(19) United States
(12) Patent Application Publication
(10) Pub. No.: US 2023/0368968 A1
(43) Pub. Date: Nov. 16, 2023

(54) TRANSFORMER WITH INTEGRATED INDUCTOR

(71) Applicant: Delta Electronics (Shanghai) Co.,Ltd., Shanghai (CN)

(72) Inventors: Quanliang ZHANG, Shanghai (CN); Shizhong GUO, Shanghai (CN); Jinping ZHOU, Shanghai (CN); Zhiheng FU, Shanghai (CN)

(21) Appl. No.: 18/186,937

(22) Filed: Mar. 20, 2023

(30) Foreign Application Priority Data
May 12, 2022 (CN) 202210520857.0

(51) Int. Cl. H01F 27/30; H01F 27/26

(52) U.S. Cl. CPC H01F 27/306; H01F 27/263

(57) ABSTRACT

The disclosure provides a transformer with an integrated inductor, including a magnetic core, a transformer winding and an inductor winding. The magnetic core comprises a magnetic yoke and magnetic columns connected to the magnetic yoke. The transformer winding is wound around at least one of the magnetic columns, and at least one transformer winding space is formed in the transformer winding. The inductor winding is at least partially accommodated in at least one magnetic yoke or at least one magnetic column of the magnetic core, so that the inductor winding penetrates through the transformer winding space formed by the transformer winding on a single magnetic column at most once, thereby decoupling the magnetic flux produced by the inductor winding from the magnetic flux produced by the transformer winding.

### CROSS-REFERENCE TO RELATED APPLICATIONS

This non-provisional application claims priority under 35 U.S.C. § 119(a) on Patent Applications No. 202210520857.0 filed on May 12, 2022, in P.R. China, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### TECHNOLOGY FIELD

The present invention relates to the technical field of magnetic integration, in particular to a transformer with an integrated inductor.

### BACKGROUND

As a common topology, LLC has a wide range of applications in various occasions, especially in D2D application. LLC topology is a common one. As shown in FIG. 1, the LLC topology may satisfy a ZVS of a device by means of resonance and thus greatly increases the efficiency of D2D at high frequency, thereby achieving the goals of high power density and high efficiency.

A distinctive feature of the LLC is to reduce the switching loss of the device by means of resonance, thereby increasing the frequency and reducing the size of a magnetic component, thereby achieving the goals of high power density and high efficiency. To meet the resonance of a circuit, a resonant inductor Lr needs to be introduced into the circuit. The inductor Lr participating in the resonance is a very important component. The size and accuracy of the inductor Lr can determine the characteristics of the operation of the circuit. At the same time, the size loss of the inductor Lr itself is a part of the performance of the whole circuit. The inductor Lr can be an independent magnetic component, but an independent inductor has no advantage due to the volume loss thereof. Therefore, the inductor Lr is generally obtained by integration into a transformer.

Currently, the inductor Lr is generally integrated in the following ways:

a method of using a leakage inductance Lk of a transformer: since the leakage inductance Lk of the transformer does not require a separate magnetic core and winding, the cost of using the leakage inductance Lk as the inductor Lr is low, but the space between primary and secondary sides of the transformer needs to be left to form the leakage inductance. Therefore, a transformer winding becomes longer and the power density of the transformer decreases. The integrated leakage inductance requires a precise control over the structure size of the winding, and the process is complicated.

A method of using magnetic core integration: a part of a magnetic core and a winding of an inductor is added outside a transformer body, and the magnetic core of the transformer part and the magnetic core of the inductor part are made into a whole. Compared with an independent inductor solution, the maximum value of the magnetic flux density may be reduced since the magnetic cores of the transformer and the inductor are a whole. However, the magnetic flux of the transformer only flows through part of the magnetic core, that is, the transformer and the inductor only share a part of the magnetic core according to said method. In addition to the magnetic core through which the magnetic flux of the transformer flows, an additional part of the magnetic core is provided for the inductor to use. Therefore, said method has the disadvantage of low power density. The additional magnetic core increases the complexity of the magnetic component.

To sum up, the existing integrated solutions often have the disadvantages of large size, low power density, high loss or low flexibility due to high transformer coupling.

### SUMMARY

For the shortcomings of the existing technology, a purpose of the present disclosure is to provide a transformer with an integrated inductor, so as to solve the technical problems of the existing magnetic integrated structure, such as large volume, low power density, high loss or low flexibility caused by high coupling of transformers and high production cost.

In order to achieve the above purpose, the present disclosure provides the following solutions:

A transformer with an integrated inductor, comprising a magnetic core, a transformer winding and an inductor winding, wherein

the magnetic core comprises a magnetic yoke and magnetic columns connected to the magnetic yoke;

the transformer winding is wound around at least one of the magnetic columns, and at least one transformer winding space is formed in the transformer winding; and

the inductor winding is at least partially accommodated in at least one magnetic yoke or at least one magnetic column of the magnetic core, so that the inductor winding penetrates through the transformer winding space formed by the transformer winding on a single magnetic column at most once, thereby decoupling the magnetic flux produced by the inductor winding from the magnetic flux produced by the transformer winding.

In some embodiments, the inductor winding is one-turn winding.

In some embodiments, the magnetic core is formed at least by splicing a first magnetic core and a second magnetic core along a direction perpendicular to the inductor winding in the magnetic core.

In some embodiments, at least one magnetic column forms an integral magnetic column, and splicing surfaces of the first magnetic core and the second magnetic core are butted to form at least an integral space penetrating through the integral magnetic column and/or the magnetic yoke; the integral space comprises an inductor winding accommodating space and an air gap of the inductor winding; and the inductor winding at least partially passes through the inductor winding accommodating space.

In some embodiments, the magnetic column comprising gap or the magnetic yoke comprising gap in the magnetic core is formed by splicing, at least one magnetic column or at least one magnetic yoke is integrally formed in the remaining magnetic column and magnetic yoke.

In some embodiments, at least one groove is formed in each the splicing surface of the first magnetic core and the second magnetic core, at least two grooves of the first magnetic core and the second magnetic core are butted to form an inductor winding accommodating space penetrating through the integral magnetic column and/or the magnetic yoke; the inductor winding at least partially passes through the inductor winding accommodating space; and a gap formed by the splicing surfaces of the first magnetic core and the second magnetic core serves as the air gap of the inductor winding.

In some embodiments, the magnetic core is formed at least by splicing the first magnetic core and the second magnetic core along an extending direction of the magnetic column.

wherein the first magnetic core comprises two integral magnetic columns, a first magnetic sub-yoke and a second magnetic sub-yoke, and the second magnetic core comprises a second magnetic yoke; wherein the first magnetic sub-yoke and the second magnetic yoke are spliced together to form a first integral magnetic yoke, and the splicing surfaces of the first magnetic sub-yoke and the second magnetic yoke are butted to form a first inductor winding accommodating space penetrating through the first integral magnetic yoke; and

the transformer winding comprises a transformer primary winding and a transformer secondary winding, and the transformer primary winding and the transformer secondary winding surround at least one of the integral magnetic columns to form the transformer winding space; and the inductor winding passes through the first inductor winding accommodating space and passes through the transformer winding space for zero times.

In some embodiments, the magnetic core further comprises a third magnetic core, and the third magnetic core comprises a third magnetic yoke; the third magnetic yoke is spliced with the second magnetic sub-yoke to form a second integral magnetic yoke, and the splicing surfaces of the third magnetic yoke and the second magnetic sub-yoke form a second inductor winding accommodating space penetrating through the second integral magnetic yoke; and

the transformer primary winding and the transformer secondary winding surround at least one of the integral magnetic columns to form a transformer winding space, and the inductor winding passes through the first inductor winding accommodating space and the second inductor winding accommodating space respectively and passes through the transformer winding space for zero times.

In some embodiments, the magnetic core comprises a magnetic yoke and at least two magnetic columns connected to the magnetic yoke; the transformer winding comprises a transformer primary winding and a transformer secondary winding, and the transformer primary winding and the transformer secondary winding surround at least one of the magnetic columns to form at least one transformer winding space; and the magnetic core is formed at least by splicing a first magnetic core and a second magnetic core along a direction perpendicular to an extending direction of the magnetic column, wherein, the first magnetic core at least comprises a first magnetic column, and the second magnetic core at least comprises a second magnetic column.

In some embodiments, the first magnetic column and the second magnetic column respectively comprise a splicing surface, and the first magnetic column and the second magnetic column are spliced to form the integral magnetic column; the splicing surfaces of the first magnetic column and the second magnetic column are butted to form the inductor winding accommodating space penetrating through the integral magnetic column; the inductor winding at least partially passes through the inductor winding accommodating space, and passes through the at least one transformer winding space once.

In some embodiments, the first magnetic core and the second magnetic core are spliced along a direction perpendicular to an extending direction of the magnetic columns; the first magnetic core comprises two first magnetic columns and two first magnetic yokes, and the second magnetic core comprises two second magnetic columns and two second magnetic yokes; the two first magnetic columns are respectively spliced with the two second magnetic columns to form two integral magnetic columns, and the two first magnetic yokes are respectively spliced with the two second magnetic yokes to form two integral magnetic yokes.

In some embodiments, the first magnetic core and the second magnetic core are spliced along a direction parallel to the upper surface of the first magnetic core; the first magnetic core comprises two first magnetic columns and two first magnetic yokes, and the second magnetic core comprises a second magnetic column, wherein one of the first magnetic columns is spliced with the second magnetic column to form the integral magnetic column; a space between splicing interfaces forms the inductor winding accommodating space; and the inductor winding penetrates through the inductor winding space, and penetrates through the transformer winding space once.

In some embodiments, the transformer primary winding and the transformer secondary winding respectively surround the two integral magnetic columns to form two transformer winding spaces, and each of the integral magnetic columns is formed by splicing one of the first magnetic columns and one of the second magnetic columns; and

the two inductor windings respectively penetrate through the two transformer winding spaces once.

In some embodiments, the magnetic core comprises a magnetic yoke and left, middle and right magnetic columns connected to the magnetic yoke; an inductor winding accommodating space is formed in the middle magnetic column along an extending direction thereof; the transformer primary winding and the transformer secondary winding are wound around the middle magnetic column, and the transformer winding space is formed by winding on the middle magnetic column; and

the inductor winding is accommodated in the inductor winding accommodating space and penetrates through the transformer winding space once.

In some embodiments, the first magnetic core further comprises two first magnetic yokes, and the second magnetic core further comprises two second magnetic yokes; an integral magnetic yoke is formed by one of the first magnetic yokes and one of the second magnetic yokes, wherein splicing surfaces of at least one of the first magnetic yokes and at least one of the second magnetic yokes are butted to form an inductor winding accommodating space penetrating through at least one of the integral magnetic yokes; and the inductor winding at least partially passes through the inductor winding accommodating space, and passes through the at least one transformer winding space for zero times.

In some embodiments, the first magnetic core comprises two first magnetic columns and two first magnetic yokes, and the second magnetic core comprises two second magnetic columns and two second magnetic yokes; each of the integral magnetic columns is formed by one of the first magnetic columns and one of the second magnetic columns, and each of the integral magnetic yokes is formed by one of the first magnetic yokes and one of the second magnetic yokes; and the inductor winding accommodating space is perpendicular to the extending direction of the magnetic column.

In some embodiments, the inductor winding accommodating space is parallel to the extending direction of the magnetic column.

In some embodiments, the extending direction of the inductor winding is parallel to the extending direction of the magnetic column, or the angle between the extending direction of the inductor winding and the extending direction of the magnetic column is less than 90°.

In some embodiments, the magnetic core comprises a magnetic yoke and four magnetic columns connected to the magnetic yoke; an inductor winding accommodating space is formed in the magnetic yoke; and the transformer primary winding and the transformer secondary winding are wound around each of the magnetic columns to form inner spaces as the transformer winding spaces respectively.

In some embodiments, the numbers of the inductor winding and the inductor winding accommodating space are respectively one or more; the inductor winding passes through the inductor winding accommodating space, and each of the inductor windings and the inductor winding accommodating space pass through the transformer winding space once or do not pass through the transformer winding space.

In some embodiments, an air gap of the inductor winding is formed in the magnetic core, and the air gap connects the inductor winding accommodating space and at least one of the magnetic columns in a penetrating manner;

wherein the cross-sectional area difference between two divided parts of the magnetic column perpendicular to the extending direction of the magnetic column is not more than 15%.

In some embodiments, the magnetic core is formed by splicing a first magnetic core and a second magnetic core along a direction perpendicular to the extending direction of the magnetic column, and the splicing surfaces thereof are at least partially located on a diagonal magnetic column,

wherein, at least one groove is formed in the splicing surfaces of the first magnetic core and the second magnetic core respectively, and after assembly, the two grooves are butted to form a hole penetrating through the magnetic core as an inductor winding accommodating space; and a gap formed by butting the splicing surfaces of the first magnetic core and the second magnetic core is used as the air gap of the inductor winding.

In some embodiments, the magnetic core is formed by splicing four or three-part magnetic columns and/or magnetic yokes, splicing surfaces are at least partially located on any two or more magnetic columns, and the gap formed by butting the splicing surfaces serves as the air gap of the inductor winding.

In some embodiments, the inductor winding and the magnetic core are integrally formed.

In some embodiments, the transformer winding comprises a transformer primary winding, and the inductor winding is directly connected in series to the transformer primary winding.

A power module, comprising the transformer with an integrated inductor according to claim 1 and an external circuit, wherein the transformer winding comprises a transformer primary winding, and an inductor winding is connected in series to the transformer primary winding through the external circuit.

Compared with the related technology, some embodiments of the invention have the following beneficial effects:

The transformer with an integrated inductor provided by the embodiment of the invention is simple to assemble and high in manufacturing efficiency. The inductor winding is completely buried in the magnetic core, occupies a small space, and basically has no influence on the overall power density.

Compared with the leakage inductance solution, the primary and secondary sides of the transformer in the transformer with an integrated inductor Lr provided by the embodiment of the invention may be wound closely together, so the transformer winding is shortened and the power density of the transformer is improved.

Compared with the magnetic integration solution, the transformer with an integrated inductor Lr provided by the embodiment of the invention does not require an additional magnetic core of the inductor part, and the magnetic flux of the transformer flows through all the magnetic cores, that is, the inductor Lr of this method completely borrows the magnetic core of the transformer, thereby increasing the power density.

### BRIEF DESCRIPTION OF THE DRAWINGS

In order to illustrate the technical solutions in the embodiments of the present disclosure more clearly, the figures required for describing the embodiments will be introduced briefly. Obviously, the figures in the description are just some of embodiments of the present disclosure. For the general technical staff in this field, they can also obtain other figures based on those figures without creative work.

FIG. 1 is a schematic diagram of a D2D circuit topology in the relating technology.

FIG. 2A is a schematic diagram of the transformer with an integrated inductor as shown in a first embodiment of the invention.

FIG. 2B is a schematic diagram of the transformer with an integrated inductor as shown in the first embodiment of the invention in another view.

FIG. 2C is a structural schematic diagram of a transformer winding space, formed by the transformer primary winding and the transformer secondary winding, in the transformer with an integrated inductor according to the first embodiment of the invention.

FIG. 3A is a schematic diagram of the transformer with an integrated inductor as shown in the second embodiment of the invention on the basis of the first embodiment.

FIG. 3B is a partial structural schematic diagram I of the magnetic core and the inductor winding as shown in the second embodiment of the invention.

FIG. 3C is a partial structural schematic diagram II of the magnetic core and the inductor winding as shown in the second embodiment of the invention.

FIG. 3D is another embodiment on the basis of the transformer with an integrated inductor as shown in the second embodiment of the invention.

FIGS. 4A-4B are structural schematic diagrams of the transformer with an integrated inductor as shown in the third embodiment of the invention.

FIG. 5A is a schematic diagram of the transformer with an integrated inductor as shown in the fourth embodiment of the invention.

FIG. 5B is a schematic diagram of the transformer with an integrated inductor as shown in the fifth embodiment of the invention on the basis of the fourth embodiment.

FIGS. 5C-5D are schematic diagrams of the transformer with an integrated inductor as shown in the sixth embodiment of the invention.

FIG. 6A is a schematic diagram of the transformer with an integrated inductor as shown in the seventh embodiment of the invention.

FIGS. 6B-6C are schematic diagrams of the transformer with an integrated inductor as shown in the eighth embodiment of the invention on the basis of the seventh embodiment.

FIG. 7A is the schematic diagram of the transformer with an integrated inductor according to the ninth embodiment of the invention.

FIG. 7B is a schematic diagram of the transformer with an integrated inductor as shown in the tenth embodiment of the invention on the basis of the ninth embodiment.

FIGS. 7C-7D are schematic diagrams of the transformer with an integrated inductor as shown in an eleventh embodiment of the invention on the basis of the ninth embodiment; and

FIG. 7E is a schematic diagram of the transformer with an integrated inductor as shown in the twelfth embodiment of the invention.

### DETAILED DESCRIPTION

The exemplary embodiments will now be described more fully with reference to the accompanying drawings. However, the exemplary embodiments can be implemented in various forms and shall not be understood as being limited to the embodiments set forth herein; on the contrary, these embodiments are provided so that the invention will be thorough and complete, and the conception of exemplary embodiments will be fully conveyed to those skilled in the art. In the drawings, the same reference sign denotes the same or similar structure, so their detailed description will be omitted.

When factors/components/the like described and/or illustrated here are introduced, the phrases “one”, “a(an)”, “the”, “said” and “at least one” refer to one or more factors/components/the like. The terms “include”, “comprise” and “have” refer to an open and included meaning, and refer to additional factors/components/the like, in addition to the listed factors/components/the like. The embodiments may use relative phrases, such as, “upper” or “lower” to describe a relative relation of one signed component over another component. It shall be understood that if the signed device reverses to turn upside down, the described component on an “upper” side will become a component on a “lower” side. In addition, the terms “first”, “second” and the like in the claims are only used as signs, instead of numeral limitations to objects.

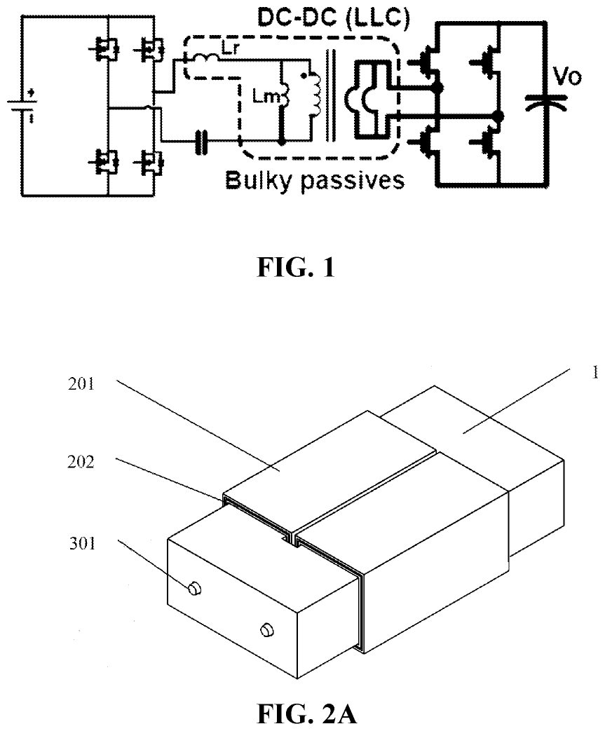

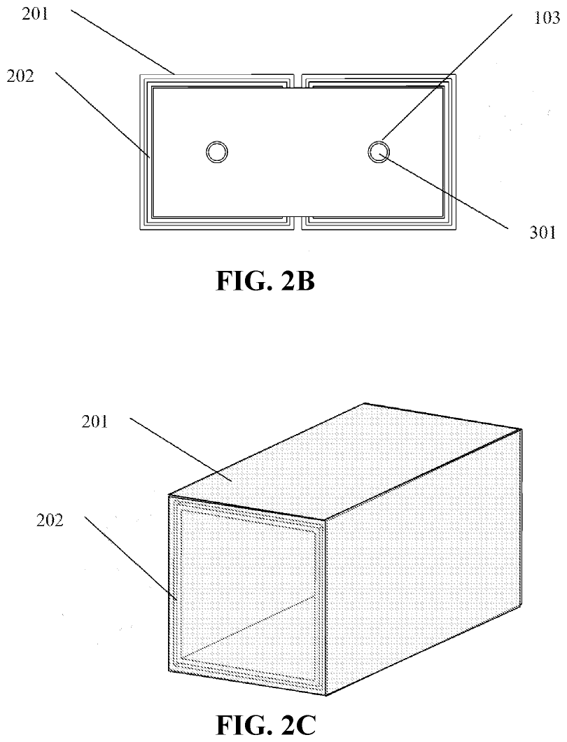

FIG. 2A is a schematic diagram of the transformer with an integrated inductor as shown in a first embodiment of the invention. FIG. 2B is a schematic diagram of the transformer with an integrated inductor as shown in the first embodiment of the invention in another view. FIG. 2C is a structural schematic diagram of a transformer winding space, formed by the transformer primary winding 201 and the transformer secondary winding 202, in the transformer with an integrated inductor in the first embodiment of the invention. In the present embodiment, the transformer comprises a magnetic core 1, a transformer primary winding 201 and a transformer secondary winding 202, wherein the magnetic core 1 comprises two magnetic yokes and two magnetic columns connected to the two magnetic yokes. Referring to FIGS. 2A and 2B, two inductor winding accommodating spaces 103 are formed on the magnetic core 1. Specifically, the inductor winding accommodating spaces 103 are formed on the two magnetic columns in the present embodiment. Two inductor windings 301 in the present embodiment pass through the inductor winding accommodating spaces 103 respectively. The transformer primary winding 201 and the transformer secondary winding 202 surround the magnetic column, and as shown in FIG. 2C, an inner space formed thereby on the two magnetic columns is a transformer winding space. In the embodiment, the inductor windings 301 penetrate in from one side of the transformer winding spaces of the two magnetic columns and penetrate out from the other side, that is, the inductor windings 301 respectively penetrate through the transformer winding spaces on the two magnetic columns once each. This structure enables the magnetic flux of the transformer to flow through all the magnetic cores, and the magnetic flux generated by the inductor winding 301 is orthogonally decoupled from the magnetic flux generated by the transformer winding, so that the transformer and the inductor can work independently. Since the magnetic core of the inductor and the magnetic core of the transformer share the same core, there is no need to provide an additional magnetic core only for the inductor, thereby increasing the power density by about 20% compared to the magnetic integration solution in the related art. As shown in FIG. 1, the inductor winding 301 can be directly connected in series with the primary winding of the transformer, or can be connected in series with the primary side by means of an external circuit. The two inductor windings 301 may be respectively connected to head and tail ends of the primary winding, or the two inductor windings 301 can be short-circuited and then connected to one end of the transformer primary winding 201. The magnetic core is integrally formed by a powder core technology. It should be noted that inner and outer positions of the transformer primary winding 201 and the transformer secondary winding 202 can be reversed.

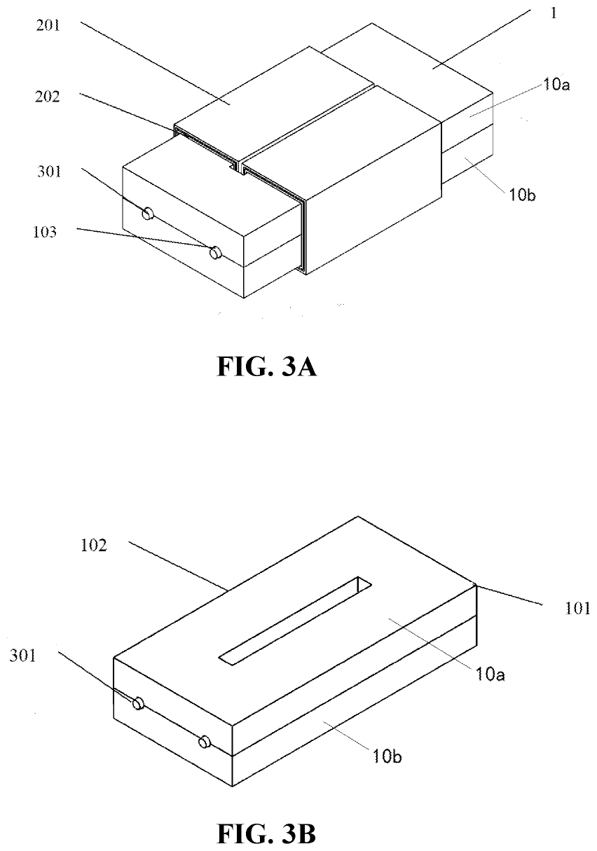

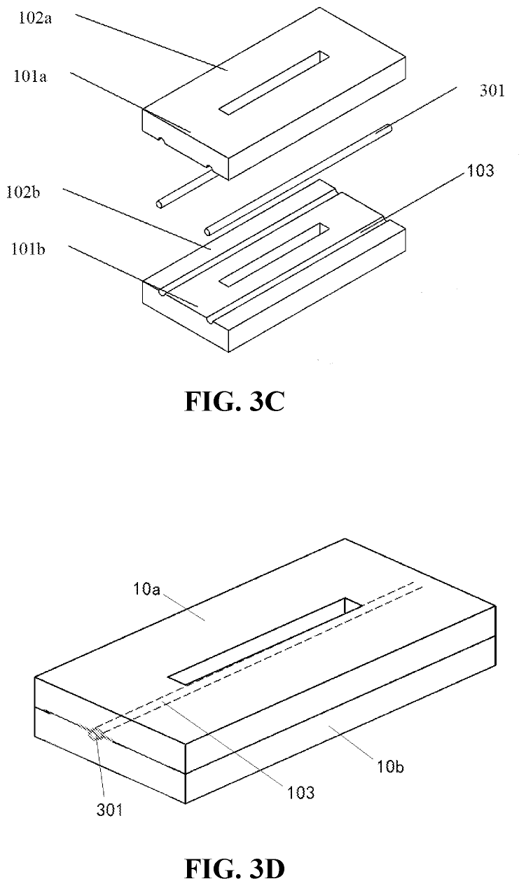

FIGS. 3A-3C are schematic diagrams of the transformer with an integrated inductor as shown in the second embodiment of the invention on the basis of the first embodiment. Specifically, FIG. 3A is a schematic diagram of the transformer with an integrated inductor as shown in the second embodiment of the invention on the basis of the first embodiment. FIG. 3B is a structural schematic diagram I of the magnetic core and the inductor winding as shown in the second embodiment of the invention. FIG. 3C is a structural schematic diagram II of the magnetic core and the inductor winding as shown in the second embodiment of the invention. Referring to FIGS. 3A-3C, in the embodiment, the magnetic core is formed by splicing a first magnetic core 10a and a second magnetic core 10b along the direction perpendicular to the extending direction of the magnetic column, that is, formed by splicing along the direction perpendicular to the inductor winding 301 in the magnetic core. The first magnetic core 10a comprises a first magnetic column 102a and a first magnetic yoke 101a, and the second magnetic core 10b comprises a second magnetic column 102b and a second magnetic yoke 101b. The first magnetic column 102a and the second magnetic column 102b constitute an integral magnetic column 102, and the first magnetic yoke 101a and the second magnetic yoke 101b constitute an integral magnetic yoke 101. Splicing surfaces of the first magnetic core 10a and the second magnetic core 10b are butted to form at least an integral space penetrating through the integral magnetic column and/or the magnetic yoke. The integral space comprises an inductor winding accommodating space and an air gap of the inductor winding 301. The gap of the inductor winding 301 is corresponding to the inductor winding 301, and has impact on the current flowing in the inductor winding 301. The inductor winding 301 at least partially passes through the inductor winding accommodating space 103. Optionally, all of the magnetic columns and magnetic yokes are formed by splicing, or the magnetic column comprising air gap or the magnetic yoke comprising air gap in the magnetic core is formed by splicing, and among the remaining magnetic columns and the magnetic yokes, at least one of the magnetic columns or at least one of the magnetic yokes is integrally formed.

In the embodiment, at least one groove is formed in the splicing surfaces of the first magnetic core 10a and the second magnetic core 10b respectively, the two grooves of the first magnetic core 10a and the second magnetic core 10b are butted to form an inductor winding accommodating space 103 penetrating through the integral magnetic column and/or the magnetic yoke; the inductor winding 301 at least partially passes through the inductor winding accommodating space 103; and a gap formed between the splicing surfaces of the first magnetic core 10a and the second magnetic core 10b serves as the air gap of the inductor winding.

Referring to FIGS. 3A-3C in detail, in the embodiment, the transformer primary winding 201 and the transformer secondary winding 202 are wound around an integral magnetic column, and the inner space formed by winding the two integral magnetic columns respectively is the transformer winding space. The inductor winding 301 penetrates in from one side of the transformer winding space of the two integral magnetic columns and penetrates out from the other side, that is, the inductor winding 301 penetrates through the transformer winding spaces on the two magnetic columns respectively once each. Two groove parts and two plane parts are formed on the splicing surfaces of the first magnetic core 10a and the second magnetic core 10b respectively. The two groove parts, after assembly, are butted to form a hole penetrating through the magnetic core 1 as the inductor winding accommodating space 103. The plane parts are butted, and a gap therebetween forms into the air gap of the inductor winding 301. In some embodiments, the first magnetic core 10a is the upper magnetic core, and the second magnetic core 10b is the lower magnetic core. Since the magnetic fluxes of the first magnetic core 10a and the second magnetic core 10b are distributed uniformly, the thickness difference 2ΔY between the first magnetic core 10a and the second magnetic core 10b does not exceed 10% of the total thickness of the integral magnetic core after the splicing. It is worth noting that in the embodiment, the inductor winding accommodating space 103 of the inductor winding 301 and the inductor winding 301 can be arranged along the extending direction of the magnetic column, or can be arranged obliquely to the extending direction of the magnetic column. It should be noted that in the embodiment, the extending direction of the inductor winding 301 is parallel to the extending direction of the magnetic column, or the angle between the extending direction of the inductor winding 301 and the extending direction of the magnetic column is less than 90°. The disclosure adopts a splicing method to simplify the assembly of the magnetic core mold and the winding, the splicing gap between the first magnetic core 10a and the second magnetic core 10b, for example the upper and lower magnetic cores, can be used to adjust the inductance of the inductor, which is easy to select circuit parameters. The splicing of the magnetic cores can be of splicing of multiples parts, which is not limited to two parts.

Further, FIG. 3D is another embodiment on the basis of the transformer with an integrated inductor as shown in the second embodiment of the invention. The transformer with an integrated inductor is similar to the structure disclosed in FIGS. 3A-3C of the second embodiment, and the same component numbers represent the same components, structures and functions, which will not be repeated here. It should be noted that, in the embodiment, the splicing surfaces of the first magnetic core 10a and the second magnetic core 10b are butted to form a space penetrating through the magnetic yoke. The space penetrates through two magnetic yokes, but does not penetrate through the magnetic column. The space comprises the inductor winding accommodating space and the air gap of the inductor winding, and the inductor winding 301 at least partially passes through the inductor winding accommodating space 103. Specifically, as shown in FIG. 3D, in the embodiment, the splicing surfaces of the two magnetic yokes of the first magnetic core 10a and the two magnetic yokes of the second magnetic core 10b are respectively provided with at least one groove, and the grooves of the two pairs of magnetic yokes are respectively butted to form an inductor winding accommodating space 103. The extending direction of the four grooves is parallel to the extending direction of the magnetic column. Therefore, the extending direction of the inductor winding accommodating space 103 formed by butting is parallel to the extending direction of the magnetic column, but the inductor winding accommodating space 103 does not pass through the magnetic column. The inductor winding 301 passes through the inductor winding accommodating space 103, and a gap formed between the splicing surfaces of the magnetic yoke serves as the air gap of the inductor winding 301. In the embodiment, the transformer primary winding 201 and the transformer secondary winding 202 are wound around the integral magnetic column, and inner spaces formed by winding on two integral magnetic columns respectively is the transformer winding space. The inductor winding 301 does not pass through from the transformer winding space between the two integral magnetic columns, that is, the inductor winding 301 penetrates through the transformer winding space on the two magnetic columns for zero times.

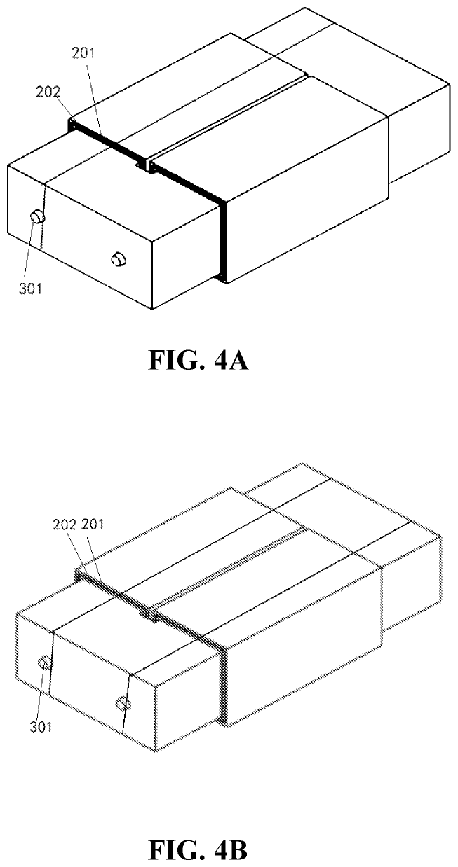

Further, FIGS. 4A-4B are structural schematic diagrams of the transformer with an integrated inductor as shown in the third embodiment of the invention. The embodiment is another embodiment based on the first embodiment of the invention. Referring to FIG. 2A and FIGS. 4A-4B, in the embodiment, the transformer comprises a magnetic core 1, a transformer primary winding 201 and a transformer secondary winding 202, wherein the magnetic core 1 comprises two magnetic yokes and two magnetic columns connected to the two magnetic yokes. Two inductor winding accommodating spaces 103 are formed on the magnetic core 1. Specifically, the inductor winding accommodating spaces 103 are formed on the two magnetic columns in the embodiment. Two inductor windings 301 in the embodiment pass through the inductor winding accommodating spaces 103 respectively. The transformer primary winding 201 and the transformer secondary winding 202 surround the magnetic column, and an inner space formed thereby on the two magnetic columns is a transformer winding space. In the embodiment, the inductor windings 301 penetrate in from one side of the transformer winding spaces of the two magnetic columns and penetrate out from the other side, that is, the inductor windings 301 respectively penetrate through the transformer winding spaces on the two magnetic columns once each. This structure enables the magnetic flux of the transformer to flow through all the magnetic cores, and the magnetic flux generated by the inductor winding 301 is orthogonally decoupled from the magnetic flux generated by the transformer winding, so that the transformer winding and the inductor winding 301 can work independently. It should be noted that the magnetic core in the embodiment is formed by splicing in the direction perpendicular to the extending direction of the two magnetic columns, and can be formed by splicing two parts or three parts, but it is not limited thereto. As shown in FIG. 4A, the magnetic core in the embodiment is formed by splicing in the direction perpendicular to the extending direction of the two magnetic columns, and can be formed by splicing two parts. The splicing surface is located in one of the magnetic columns. At this time, one of the magnetic columns in the transformer is formed by splicing a first magnetic sub-column and a second magnetic sub-column, and the other magnetic column is an integral magnetic column. The two magnetic yokes are formed by splicing two magnetic sub-yokes, that is the first magnetic sub-yoke and the second magnetic sub-yoke. As shown in FIG. 4B, the magnetic core in the embodiment is formed by splicing in the direction perpendicular to the extending direction of the two magnetic columns, and can be formed by splicing three parts. The first magnetic column and the second magnetic column of the magnetic core respectively comprise a splicing surface, the first magnetic column and the second magnetic column both comprise a first magnetic sub-column and a second magnetic sub-column. The first magnetic sub-column and the second magnetic sub-column are spliced to form an integral magnetic column, and spliced surfaces thereof are butted to form an inductor winding accommodating space 103 penetrating through the integral magnetic column and passing through the at least one transformer winding space once.

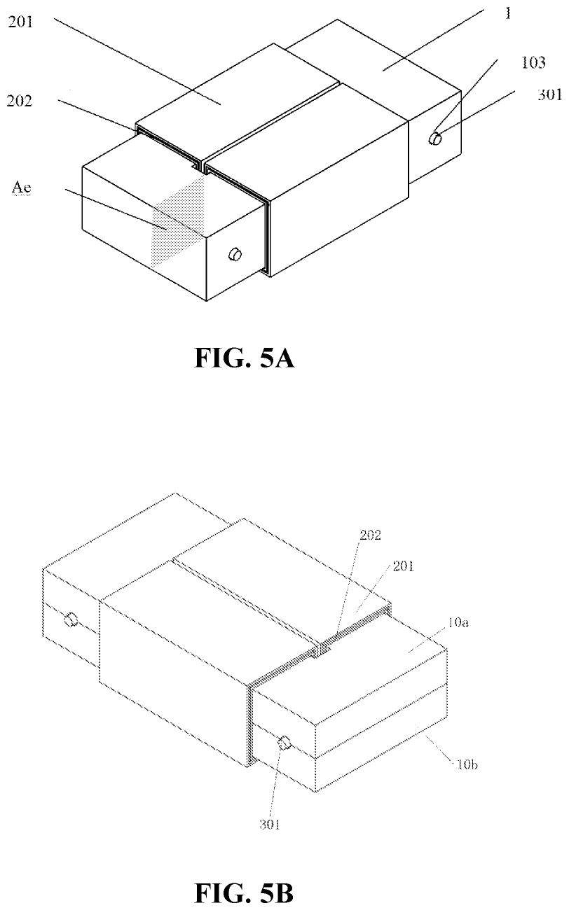

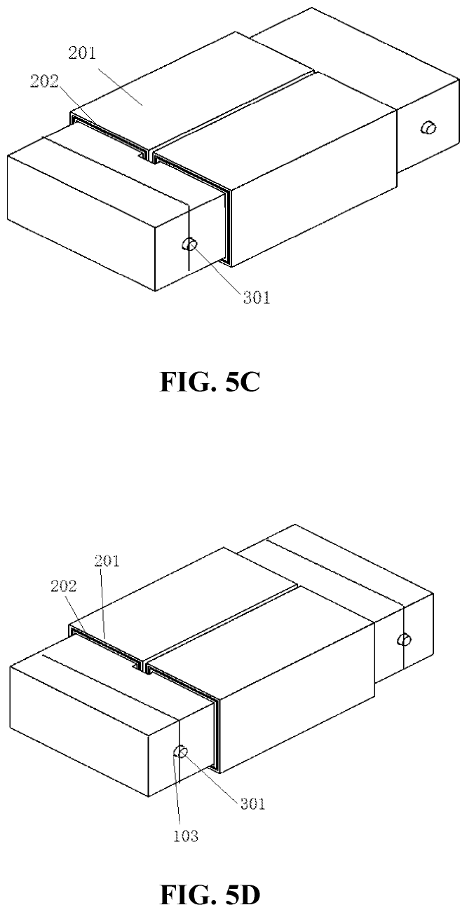

FIG. 5A is a schematic diagram of the transformer with an integrated inductor according to the fourth embodiment of the invention. The magnetic core 1, the transformer primary winding 201 and the transformer secondary winding 202 constitute a transformer. In the embodiment, the magnetic core 1 is composed of two magnetic columns and two magnetic yokes connected to the two magnetic columns. The magnetic yoke comprises an inductor winding accommodating space 103. In the embodiment, the inductor winding accommodating space 103 is perpendicular to the extending direction of the magnetic column. The transformer primary winding 201 and the transformer secondary winding 202 are wound around the magnetic column, and an inner space formed by windings on two integral magnetic columns respectively is the transformer winding space. The inductor winding 301 does not pass through the transformer winding space, that is, the inductor winding 301 penetrates through the transformer winding space on the two magnetic columns for zero times. This structure enables the magnetic flux generated by the inductor winding 301 to be orthogonally decoupled from the magnetic flux generated by the transformer winding, so that the transformer winding and the inductor winding 301 can work independently. The space occupied by the inductor winding has no effect on the turn length of the transformer winding. Since the magnetic yoke is not covered with windings, the cross-sectional area of the magnetic column and the cross-sectional area of the magnetic yoke may be adjusted independently, which increases the flexibility of inductor parameters and is easy for circuit design.

It is worth noting that in the embodiment, the inductor winding 301 can be pre-placed in a magnetic core mold and integrally formed with the magnetic core, or can be arranged in a magnetic core formed by splicing two or three-part magnetic cores in a direction perpendicular to or parallel to the extending direction of the magnetic column.

FIG. 5B is a schematic diagram of the transformer with an integrated inductor according to the fifth embodiment of the invention on the basis of the fourth embodiment. As shown in FIG. 5B, in the embodiment, the magnetic core is formed by splicing a first magnetic core 10a and a second magnetic core 10b along the direction perpendicular to an extending direction of the magnetic column. The first magnetic core 10a is composed of two first magnetic columns and two first magnetic yokes, and the second magnetic core 10b is composed of two second magnetic columns and two second magnetic yokes. The first magnetic column and the second magnetic column constitute an integral magnetic column, and the first magnetic yoke and the second magnetic yoke constitute an integral magnetic yoke. In the embodiment, a groove is formed in the splicing surfaces of the first magnetic yoke and the second magnetic yoke respectively, and the two grooves of the first magnetic yoke and the second magnetic yoke are butted to form an inductor winding accommodating space 103 of the integral magnetic yoke. The inductor winding at least partially passes through the inductor winding accommodating space 103, and the gap formed by butting the splicing surfaces of the first magnetic core 10a and the second magnetic core 10b serves as the air gap of the inductor winding 301. At this time, the transformer primary winding 201 and the transformer secondary winding 202 are wound around the magnetic column, and an inner space formed by windings on two magnetic columns respectively is the transformer winding space. The inductor winding 301 does not pass through the transformer winding space, that is, the inductor winding 301 penetrates through the transformer winding space on the two magnetic columns for zero times.

Further, reference is made to FIGS. 5C-5D which are schematic diagrams of the transformer with an integrated inductor according to the sixth embodiment of the invention. As shown in FIG. 5C, the magnetic core in the embodiment is formed by splicing a first magnetic core and a second magnetic core along a direction parallel to an extending direction of the magnetic column. The first magnetic core comprises two integral magnetic columns, a first magnetic sub-yoke and a second magnetic sub-yoke. The second magnetic core comprises a second magnetic yoke, wherein the second magnetic sub-yoke is used as a magnetic yoke, the first magnetic sub-yoke and the second magnetic yoke are spliced to form an integral magnetic yoke, and splicing surfaces of the first magnetic sub-yoke and the second magnetic yoke are butted to form an inductor winding accommodating space penetrating through the integral magnetic yoke. That is, two grooves of the first magnetic sub-yoke and the second magnetic yoke are butted to form an inductor winding accommodating space 103 of an integral magnetic yoke. The inductor winding 301 at least partially passes through the inductor winding accommodating space 103, and a gap formed by butting splicing surfaces thereof serves as the air gap of the inductor winding. At this time, the transformer primary winding 201 and the transformer secondary winding 202 are wound around the magnetic column, and an inner space formed by windings on two integral magnetic columns respectively is the transformer winding space. The inductor winding 301 does not pass through the transformer winding space, that is, the inductor winding 301 penetrates through the transformer winding space on the two magnetic columns for zero times.

Further, as shown in FIG. 5D, the magnetic core in the embodiment can consist of a first magnetic core, a second magnetic core and a third magnetic core. The first magnetic core comprises two integral magnetic columns, a first magnetic sub-yoke and a second magnetic sub-yoke; the second magnetic core comprises a second magnetic yoke; and the third magnetic core comprises a third magnetic yoke. In the embodiment, the first magnetic sub-yoke and the second magnetic yoke can constitute an integral magnetic yoke, and a groove is respectively formed in splicing surfaces between the first magnetic sub-yoke and the second magnetic yoke. The two grooves of the first magnetic sub-yoke and the second magnetic yoke are butted to form an inductor winding accommodating space 103 of an integral magnetic yoke. The second magnetic sub-yoke and the third magnetic yoke can constitute an integral magnetic yoke. A groove is respectively formed in splicing surfaces between the second magnetic sub-yoke and the third magnetic yoke. The two grooves of the second magnetic sub-yoke and the third magnetic yoke are butted to form an inductor winding accommodating space 103 of an integral magnetic yoke. The inductor winding 301 at least partially passes through the inductor winding accommodating space 103, and a gap formed by butting the splicing surfaces thereof serves as the air gap of the inductor winding 301. At this time, the transformer primary winding 201 and the transformer secondary winding 202 are wound around the magnetic column, and an inner space formed by windings on two integral magnetic columns respectively is the transformer winding space. The inductor winding 301 does not pass through the transformer winding space, that is, the inductor winding 301 penetrates through the transformer winding space on the two magnetic columns for zero times.

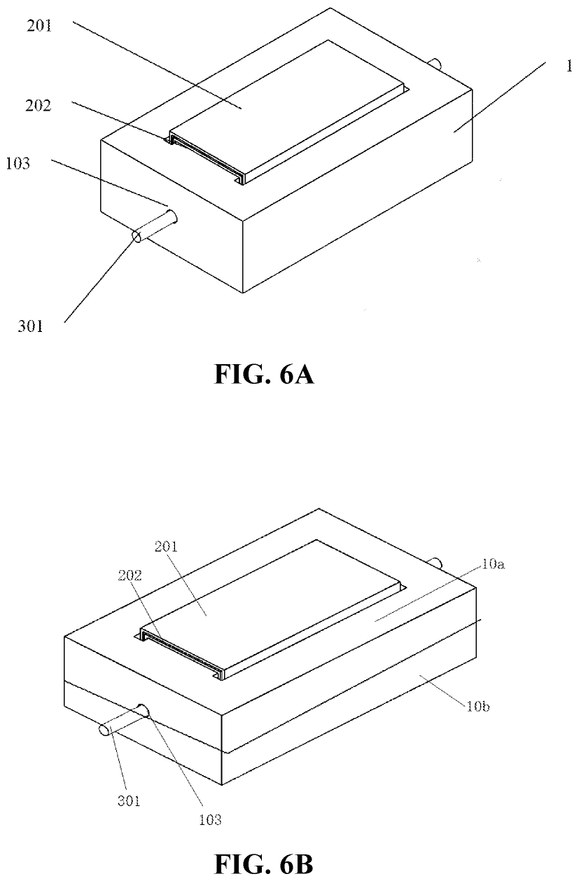

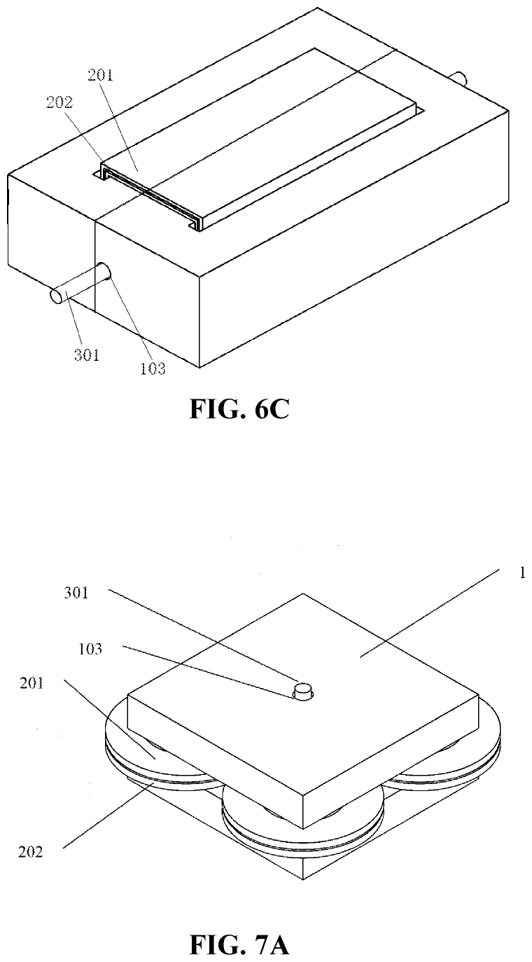

FIG. 6A is a schematic diagram of a transformer with an integrated inductor according to the seventh embodiment of the invention, the structure being a transformer in a three-column structure. The transformer comprises a magnetic core 1, a transformer primary winding 201 and a transformer secondary winding 202. The magnetic core comprises a magnetic yoke and left, middle and right magnetic columns connected to the magnetic yoke. An inductor winding accommodating space 103 is formed in the middle magnetic column along an extending direction thereof. The transformer primary winding 201 and the transformer secondary winding 202 are wound around the middle magnetic column, and the transformer winding space is formed by windings on the middle magnetic column. The inductor winding 301 is accommodated in the inductor winding accommodating space 103 and penetrates through the transformer winding space once. For the magnetic core in this structure, only the middle column is wrapped by the winding and thus has a relatively large exposed area. Therefore, the magnetic core has a better heat dissipation effect, which is more conducive to the heat dissipation of the magnetic core in case of high loss.

Further, the magnetic core in the present embodiment may also be formed by splicing two parts in a direction perpendicular to the extension direction of the magnetic column. Reference is made to FIGS. 6B-6C which are schematic diagrams of the transformer with an integrated inductor as shown in the eighth embodiment of the invention on the basis of the seventh embodiment. As shown in FIG. 6B, the magnetic core in the embodiment is formed by splicing two upper and lower magnetic core parts, for example the first magnetic core 10a and the second magnetic core 10b, and the middle magnetic column includes the first sub-magnetic column and the second sub-column arranged up and down. A groove is formed along the extending direction of the middle column in the splicing surface. An inductor winding accommodating space 103 is formed by two grooves along the extending direction of the middle magnetic column. The transformer primary winding 201 and the transformer secondary winding 202 are wound around the middle magnetic column, and the transformer winding space is formed by windings on the middle magnetic column. The inductor winding 301 is accommodated in the inductor winding accommodating space 103 and penetrates through the transformer winding space once. As shown in FIG. 6C, the magnetic core in the embodiment is formed by splicing two magnetic core parts in the horizontal direction, the two magnetic core parts are formed by splicing together along a direction perpendicular to the extension direction of the magnetic column, and the middle magnetic column comprises a first magnetic sub-column and a second magnetic sub-column which are horizontally arranged. A groove is formed along the extending direction of the middle column in the splicing surface. An inductor winding accommodating space 103 is formed in two grooves on the extending direction of the middle magnetic column. The transformer primary winding 201 and the transformer secondary winding 202 are wound around the middle magnetic column, and the transformer winding space is formed by windings on the middle magnetic column. The inductor winding 301 is accommodated in the inductor winding accommodating space 103 and penetrates through the transformer winding space once.

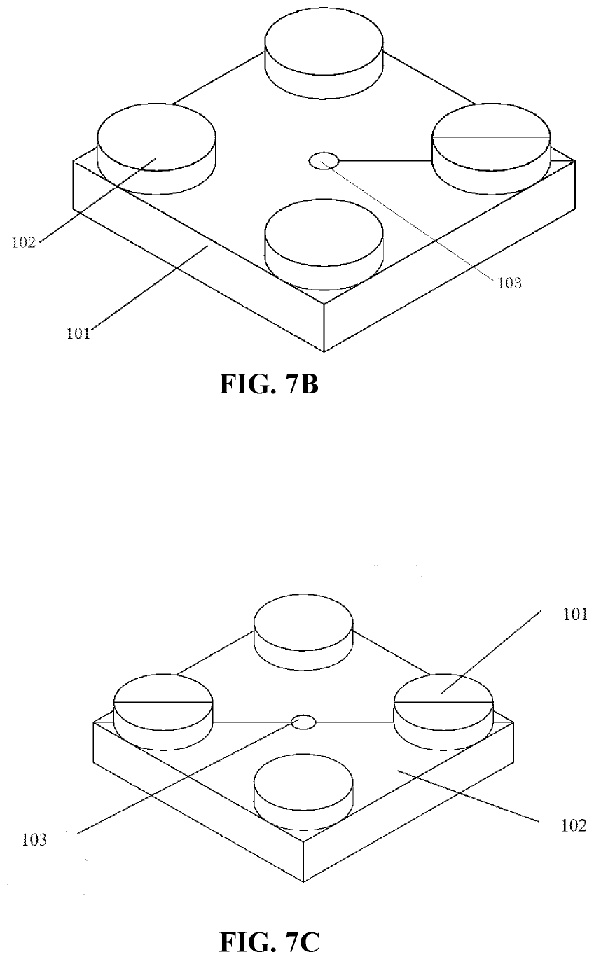

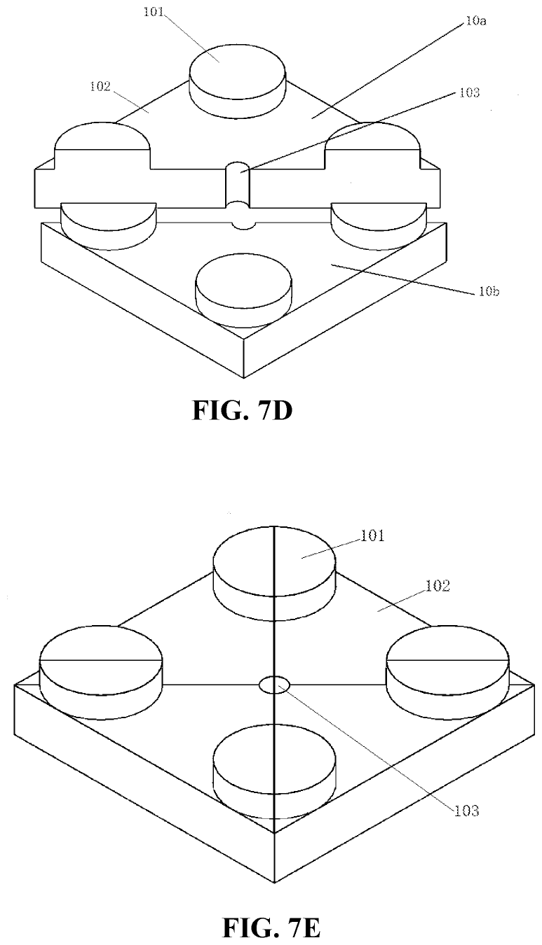

FIG. 7A is a schematic diagram of the transformer with an integrated inductor according to the ninth embodiment of the invention, the structure being a transformer in a four-column structure. In the embodiment, the magnetic core comprises a magnetic yoke and four magnetic columns connected to the magnetic yoke. An inductor winding accommodating space 103 is formed in the magnetic yoke. The transformer primary winding 201 and the transformer secondary winding 202 are wound around each of the magnetic columns to form inner spaces as the transformer winding spaces respectively. It should be noted that in the embodiment, the numbers of the inductor winding 301 and the inductor winding accommodating space 103 can be one or more. In addition, in the embodiment, the inductor winding 301 passes through the inductor winding accommodating space 103. Each of the inductor windings 301 and the inductor winding accommodating space 103 do not pass through the transformer winding space, that is, the inductor winding 301 penetrates through the transformer winding space on the magnetic column for zero times. In the structure of the embodiment, the magnetic flux generated by the inductor winding 301 only close in the magnetic yoke and does not flow through the magnetic column, and is decoupled from the magnetic flux generated by the transformer winding, so that the transformer winding and the inductor winding can work independently. It is also suitable for transformers with more magnetic column structures. It is worth noting that in the embodiment, a plurality of inductor windings and a plurality of inductor winding accommodating spaces can also be provided on the magnetic core 1, and the inductor winding 301 passes through the inductor winding accommodating space 103. In addition, the plurality of inductor windings and the plurality of inductor winding accommodating spaces can pass through or do not pass through any magnetic column. The transformer in this structure does not increase the magnetic potential outside the magnetic core while integrating the inductor, which can avoid the problem of increased loss caused by the magnetic potential.

FIG. 7B is a schematic diagram of the transformer with an integrated inductor according to the tenth embodiment of the invention on the basis of the ninth embodiment, the structure being a transformer in a four-column structure. The magnetic core disclosed in the embodiment has a slit as the air gap of the inductor, which penetrates through and connects the inductor winding accommodating space 103 and a magnetic column. In order to the Bmax deviation is less than 15% between the two parts of the divided magnetic column, the cross-sectional area difference between the two parts of the divided magnetic column perpendicular to the extension direction of the magnetic column is not more than 15%. At the same time, it does not affect the distribution of the main magnetic flux of the transformer, so as to ensure that the magnetic flux coupling relationship between the four columns of the transformer remains unchanged.

FIGS. 7C-7D are schematic diagrams of the transformer with an integrated inductor according to the eleventh embodiment of the invention on the basis of the ninth embodiment, the structure being a transformer in a four-column structure. The magnetic core is formed by splicing a first magnetic core and a second magnetic core along a direction perpendicular to the extending direction of the magnetic column, and splicing surfaces thereof are at least partially located on a diagonal magnetic column, wherein, at least one groove is formed in the splicing surfaces of the first magnetic core 10a and the second magnetic core 10b respectively, and the two grooves, after assembly, are butted to form a hole penetrating through the magnetic core as an inductor winding accommodating space 103. A gap formed by butting the splicing surfaces of the first magnetic core and the second magnetic core is used as the air gap of the inductor winding 301. This structure simplifies the manufacturing method for the air gap.

Further, reference is made to FIG. 7E which is a structural schematic diagram of the transformer with an integrated inductor according to the twelfth embodiment of the invention. In the embodiment, the magnetic core is formed by splicing four or three-part magnetic columns and/or magnetic yokes, splicing surfaces are at least partially located on any two or more magnetic columns, and a gap formed by butting the splicing surfaces serves as the air gap of the inductor winding 301. Compared with the two-part composition, the number of the air gaps in the magnetic core is larger. Therefore, under the same conditions, each air gap can be smaller, and the loss caused by removing flux leakage from the air gap can also be lower.

It should be noted that, in the invention, the inductor winding can be placed in a pre-formed inductor winding accommodating space of the magnetic core, or the inductor winding and the magnetic core can be integrally formed.

In the present disclosure, the transformer winding comprises a transformer primary winding, and the inductor winding is directly connected in series to the transformer primary winding.

Another embodiment of the invention provides a power module, comprising the transformer with an integrated inductor and an external circuit. The transformer winding comprises a transformer primary winding, and an inductor winding is connected in series to the transformer primary winding by means of the external circuit.

The transformer with an integrated inductor provided by the embodiment of invention is simple to assemble and high in manufacturing efficiency. The inductor winding is completely buried in the magnetic core, occupies a small space, and basically has no influence on the overall power density.

Compared with the leakage inductor solution, in the embodiments of the present invention, there is no need to reserve space for the primary and secondary sides of the transformer to form leakage inductor, so the transformer winding is shortened and the power density of the transformer is improved.

Compared with the magnetic integration solution, the transformer with an integrated inductor provided by the invention does not require an additional magnetic core of the inductor part, so the power density is increased.

The above are only embodiments of the present invention, and are not intended to limit the present invention in other forms. Any person skilled in the art may use the technical contents disclosed above to make changes or modifications into equivalent embodiments with equivalent changes and apply the same to other fields. However, any simple alterations, equivalent changes and modifications made on the embodiments above according to the technical essence of the present invention without departing from the content of the technical solutions of the present invention still belong to the scope of protection of the technical solutions of the present invention.

What is claimed is:

1. A transformer with an integrated inductor, comprising a magnetic core, a transformer winding and an inductor winding, wherein
the magnetic core comprises a magnetic yoke and magnetic columns connected to the magnetic yoke;
the transformer winding is wound around at least one of the magnetic columns, and at least one transformer winding space is formed in the transformer winding; and
the inductor winding is at least partially accommodated in at least one magnetic yoke or at least one magnetic column of the magnetic core, so that the inductor winding penetrates through the transformer winding space formed by the transformer winding on a single magnetic column at most once, thereby decoupling the magnetic flux produced by the inductor winding from the magnetic flux produced by the transformer winding.

2. The transformer with an integrated inductor according to claim 1, wherein the inductor winding is one-turn winding.

3. The transformer with an integrated inductor according to claim 1, wherein the magnetic core is formed at least by splicing a first magnetic core and a second magnetic core along a direction perpendicular to the inductor winding in the magnetic core.

4. The transformer with an integrated inductor according to claim 3, wherein at least one magnetic column forms an integral magnetic column, and splicing surfaces of the first magnetic core and the second magnetic core are butted to form at least an integral space penetrating through the integral magnetic column and/or the magnetic yoke; the integral space comprises an inductor winding accommodating space and an air gap of the inductor winding; and the inductor winding at least partially passes through the inductor winding accommodating space.

5. The transformer with an integrated inductor according to claim 4, wherein the magnetic column comprising gap or the magnetic yoke comprising gap in the magnetic core is formed by splicing, at least one magnetic column or at least one magnetic yoke is integrally formed in the remaining magnetic column and magnetic yoke.

6. The transformer with an integrated inductor according to claim 4, wherein at least one groove is formed in each the splicing surface of the first magnetic core and the second magnetic core, at least two grooves of the first magnetic core and the second magnetic core are butted to form an inductor winding accommodating space penetrating through the integral magnetic column and/or the magnetic yoke; the inductor winding at least partially passes through the inductor winding accommodating space; and a gap formed by the splicing surfaces of the first magnetic core and the second magnetic core serves as the air gap of the inductor winding.

7. The transformer with an integrated inductor according to claim 4, wherein the magnetic core is formed at least by splicing the first magnetic core and the second magnetic core along an extending direction of the magnetic column,
wherein the first magnetic core comprises two integral magnetic columns, a first magnetic sub-yoke and a second magnetic sub-yoke, and the second magnetic core comprises a second magnetic yoke; wherein the first magnetic sub-yoke and the second magnetic yoke are spliced together to form a first integral magnetic yoke, and the splicing surfaces of the first magnetic sub-yoke and the second magnetic yoke are butted to form a first inductor winding accommodating space penetrating through the first integral magnetic yoke; and
the transformer winding comprises a transformer primary winding and a transformer secondary winding, and the transformer primary winding and the transformer secondary winding surround at least one of the integral magnetic columns to form the transformer winding space; and the inductor winding passes through the first inductor winding accommodating space and passes through the transformer winding space for zero times.

8. The transformer with an integrated inductor according to claim 7, wherein
the magnetic core further comprises a third magnetic core, and the third magnetic core comprises a third magnetic yoke; the third magnetic yoke is spliced with the second magnetic sub-yoke to form a second integral magnetic yoke, and the splicing surfaces of the third magnetic yoke and the second magnetic sub-yoke form a second inductor winding accommodating space penetrating through the second integral magnetic yoke; and
the transformer primary winding and the transformer secondary winding surround at least one of the integral magnetic columns to form a transformer winding space, and the inductor winding passes through the first inductor winding accommodating space and the second inductor winding accommodating space respectively and passes through the transformer winding space for zero times.

9. The transformer with an integrated inductor according to claim 4, wherein the magnetic core comprises a magnetic yoke and at least two magnetic columns connected to the magnetic yoke; the transformer winding comprises a transformer primary winding and a transformer secondary winding, and the transformer primary winding and the transformer secondary winding surround at least one of the magnetic columns to form at least one transformer winding space; and the magnetic core is formed at least by splicing a first magnetic core and a second magnetic core along a direction perpendicular to an extending direction of the magnetic column, wherein, the first magnetic core at least comprises a first magnetic column, and the second magnetic core at least comprises a second magnetic column.

10. The transformer with an integrated inductor according to claim 9, wherein
the first magnetic column and the second magnetic column respectively comprise a splicing surface, and the first magnetic column and the second magnetic column are spliced to form the integral magnetic column; the splicing surfaces of the first magnetic column and the second magnetic column are butted to form the inductor winding accommodating space penetrating through the integral magnetic column; the inductor winding at least partially passes through the inductor winding accommodating space, and passes through the at least one transformer winding space once.

11. The transformer with an integrated inductor according to claim 10, wherein the first magnetic core and the second magnetic core are spliced along a direction perpendicular to an extending direction of the magnetic columns; the first magnetic core comprises two first magnetic columns and two first magnetic yokes, and the second magnetic core comprises two second magnetic columns and two second magnetic yokes; the two first magnetic columns are respectively spliced with the two second magnetic columns to form two integral magnetic columns, and the two first magnetic yokes are respectively spliced with the two second magnetic yokes to form two integral magnetic yokes.

12. The transformer with an integrated inductor according to claim 10, wherein
the first magnetic core and the second magnetic core are spliced along a direction parallel to the upper surface of the first magnetic core; the first magnetic core comprises two first magnetic columns and two first magnetic yokes, and the second magnetic core comprises a second magnetic column, wherein one of the first magnetic columns is spliced with the second magnetic column to form the integral magnetic column; a space between splicing interfaces forms the inductor winding accommodating space; and the inductor winding penetrates through the inductor winding space, and penetrates through the transformer winding space once.

13. The transformer with an integrated inductor according to claim 10, wherein the transformer primary winding and the transformer secondary winding respectively surround the two integral magnetic columns to form two transformer winding spaces, and each of the integral magnetic columns is formed by splicing one of the first magnetic columns and one of the second magnetic columns; and
the two inductor windings respectively penetrate through the two transformer winding spaces once.

14. The transformer with an integrated inductor according to claim 10, wherein
the magnetic core comprises a magnetic yoke and left, middle and right magnetic columns connected to the magnetic yoke; an inductor winding accommodating space is formed in the middle magnetic column along an extending direction thereof; the transformer primary winding and the transformer secondary winding are wound around the middle magnetic column, and the transformer winding space is formed by winding on the middle magnetic column; and
the inductor winding is accommodated in the inductor winding accommodating space and penetrates through the transformer winding space once.

15. The transformer with an integrated inductor according to claim 4, wherein
the first magnetic core further comprises two first magnetic yokes, and the second magnetic core further comprises two second magnetic yokes; an integral magnetic yoke is formed by one of the first magnetic yokes and one of the second magnetic yokes, wherein splicing surfaces of at least one of the first magnetic yokes and at least one of the second magnetic yokes are butted to form an inductor winding accommodating space penetrating through at least one of the integral magnetic yokes; and the inductor winding at least partially passes through the inductor winding accommodating space, and passes through the at least one transformer winding space for zero times.

16. The transformer with an integrated inductor according to claim 15, wherein the first magnetic core comprises two first magnetic columns and two first magnetic yokes, and the second magnetic core comprises two second magnetic columns and two second magnetic yokes; each of the integral magnetic columns is formed by one of the first magnetic columns and one of the second magnetic columns, and each of the integral magnetic yokes is formed by one of the first magnetic yokes and one of the second magnetic yokes; and the inductor winding accommodating space is perpendicular to the extending direction of the magnetic column.

17. The transformer with an integrated inductor according to claim 15, wherein the inductor winding accommodating space is parallel to the extending direction of the magnetic column.

18. The transformer with an integrated inductor according to claim 10, wherein the extending direction of the inductor winding is parallel to the extending direction of the magnetic column, or the angle between the extending direction of the inductor winding and the extending direction of the magnetic column is less than 90°.

19. The transformer with an integrated inductor according to claim 17, wherein the magnetic core comprises a magnetic yoke and four magnetic columns connected to the magnetic yoke; an inductor winding accommodating space is formed in the magnetic yoke;
and the transformer primary winding and the transformer secondary winding are wound around each of the magnetic columns to form inner spaces as the transformer winding spaces respectively.

20. The transformer with an integrated inductor according to claim 19, wherein the numbers of the inductor winding and the inductor winding accommodating space are respectively one or more; the inductor winding passes through the inductor winding accommodating space, and each of the inductor windings and the inductor winding accommodating space pass through the transformer winding space once or do not pass through the transformer winding space.

21. The transformer with an integrated inductor according to claim 19, wherein an air gap of the inductor winding is formed in the magnetic core, and the air gap connects the inductor winding accommodating space and at least one of the magnetic columns in a penetrating manner;
wherein the cross-sectional area difference between two divided parts of the magnetic column perpendicular to the extending direction of the magnetic column is not more than 15%.

22. The transformer with an integrated inductor according to claim 19, wherein the magnetic core is formed by splicing a first magnetic core and a second magnetic core along a direction perpendicular to the extending direction of the magnetic column, and the splicing surfaces thereof are at least partially located on a diagonal magnetic column,
wherein, at least one groove is formed in the splicing surfaces of the first magnetic core and the second magnetic core respectively, and after assembly, the two grooves are butted to form a hole penetrating through the magnetic core as an inductor winding accommodating space; and a gap formed by butting the splicing surfaces of the first magnetic core and the second magnetic core is used as the air gap of the inductor winding.

23. The transformer with an integrated inductor according to claim 19, wherein the magnetic core is formed by splicing four or three-part magnetic columns and/or magnetic yokes, splicing surfaces are at least partially located on any two or more magnetic columns, and the gap formed by butting the splicing surfaces serves as the air gap of the inductor winding.

24. The transformer with an integrated inductor according to claim 1, wherein the inductor winding and the magnetic core are integrally formed.

25. The transformer with an integrated inductor according to claim 1, wherein the transformer winding comprises a transformer primary winding, and the inductor winding is directly connected in series to the transformer primary winding.

26. A power module, comprising the transformer with an integrated inductor according to claim 1 and an external circuit, wherein the transformer winding comprises a transformer primary winding, and an inductor winding is connected in series to the transformer primary winding through the external circuit.
